(19) United States
(12) Patent Application Publication
(10) Pub. No.: US 2025/0271614 A1
(43) Pub. Date: Aug. 28, 2025

(54) WAVEGUIDE WITH TRANSITIONAL PORTION AND METHOD OF FABRICATING SAME

(71) Applicant: Taiwan Semiconductor Manufacturing Company, LTD., Hsinchu (TW)

(72) Inventors: Tsung-Lin Hsieh, Hsinchu (TW); Wei-Jhih Mao, Taipei (TW); Cheng-Tse Tang, Hsinchu (TW); Wen-Tuan Lo, Hsinchu (TW); Shang-Ying Tsai, Pingzhen (TW); Chun-Heng Chen, Hsinchu (TW); Yingkit Felix Tsui, Cupertino, CA (US)

(21) Appl. No.: 18/584,047

(22) Filed: Feb. 22, 2024

(51) Int. Cl. G02B 6/122; G02B 6/12; G02B 6/132; G02B 6/136

(52) U.S. Cl. CPC G02B 6/1228; G02B 6/132; G02B 6/136; G02B 2006/12038; G02B 2006/12061; G02B 2006/12176; G02B 2006/12197

(57) ABSTRACT

A waveguide has a first and second portions, and a transitional portion with a first end joining the first portion and a second end joining the second portion. The first portion has a first thickness that is smaller than a second thickness of the second portion. The transitional portion has a thickness that gradually increases from the first thickness at its first end to the second thickness at its second end. In a fabrication method employing chemical-mechanical polishing (CMP), first and second CMP control structures are disposed on opposite sides of the waveguide. Spaces between the waveguide and the CMP control structures are filled with cladding material. CMP is performed to reduce a thickness of the waveguide. The CMP control structures control the CMP of the waveguide to form the transitional portion of the waveguide having the gradually increasing thickness.

### BACKGROUND

The following relates to optical waveguides, methods of making optical waveguides, optical waveguide couplings, and the like.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 diagrammatically illustrates a top view of an optical structure including a waveguide.

FIG. 2 diagrammatically illustrates a cut view of the waveguide of the optical structure of FIG. 1 taken along cut C0-C0 indicated in FIG. 1.

FIG. 3 diagrammatically illustrates the top view of the optical structure of FIGS. 1 and 2, with certain dimensions labeled and with cut planes indicated for a cut C1-C1, a cut C2-C2, and a cut C3-C3.

FIG. 4 diagrammatically illustrates the cut view of the waveguide of FIG. 2, with certain dimensions labeled, and with the cut planes indicated for the same cuts C1-C1, C2-C2, and C3-C3 indicated in FIG. 3.

FIGS. 5A, 5B, 5C, 5D, 5E, 5F, 5G, and 5H diagrammatically illustrate cut C3-C3 indicated in FIGS. 3 and 4 at successive steps of a waveguide fabrication process.

FIG. 6 diagrammatically illustrates two cut views taken along cut C1-C1 indicated in FIGS. 3 and 4, with the left-hand cut view depicting the structure before CMP and the right-hand cut view depicting the structure after CMP.

FIG. 7 diagrammatically illustrates two cut views taken along cut C2-C2 indicated in FIGS. 3 and 4, with the left-hand cut view depicting the structure before CMP and the right-hand cut view depicting the structure after CMP.

FIG. 8 diagrammatically illustrates two cut views taken along cut C3-C3 indicated in FIGS. 3 and 4, with the left-hand cut view depicting the structure before CMP and the right-hand cut view depicting the structure after CMP.

FIG. 9 diagrammatically illustrates a cut view of an optical waveguide having a portion with a continuously varying waveguide height, delivering light to an optical detector.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Silicon waveguides are used as silicon photonic components, integrated electrical/optical circuits, or the like. A silicon waveguide typically employs silicon as the higher refractive index core that carries the light, and silicon dioxide as a cladding having lower refractive index. Silicon waveguides are manufactured using principally silicon and silicon dioxide, and are well suited for integration with existing silicon-based microelectronic and integrated circuit (IC) technologies.

In certain applications, it may be useful for the silicon waveguide to have portions with different thicknesses (i.e., different heights). For example, a light input coupling waveguide portion may have a reduced height that is optimized to match with the size of a light emitter, or a photodetector coupling may have a larger height optimized to match a photodetector, as two nonlimiting illustrative examples. Having waveguide portions with different heights increases the manufacturing complexity, as each different thickness (i.e., height) in the silicon waveguide entails an additional photolithographic patterning and etching process sequence.

A further issue is that each change in height of a portion of a waveguide introduces an abrupt step in the height of the waveguide. Light reflection occurs at the height step, and the reflected light constitutes optical loss. The light reflection can also produce undesirable destructive optical interference. In the case of polychromatic light, the amount of reflection and constructive or destructive interference can be wavelength-dependent, which can produce undesirable wavelength dependence on the transmission efficiency of the waveguide.

In the following, improved waveguides are disclosed which advantageously provide a gradual transition between waveguide portions of different thicknesses (i.e., different heights), without an abrupt step. The gradual transition substantially reduces or eliminates light reflection at the transition. Also disclosed herein are methods of manufacturing such improved waveguides, which advantageously achieve the gradual transition from one thickness to another without multiple photolithographic patterning and etching process sequences. The disclosed manufacturing processes utilize a chemical-mechanical polishing (CMP) process controlled by a CMP control structure to form a transitional portion of the waveguide having a gradually changing thickness.

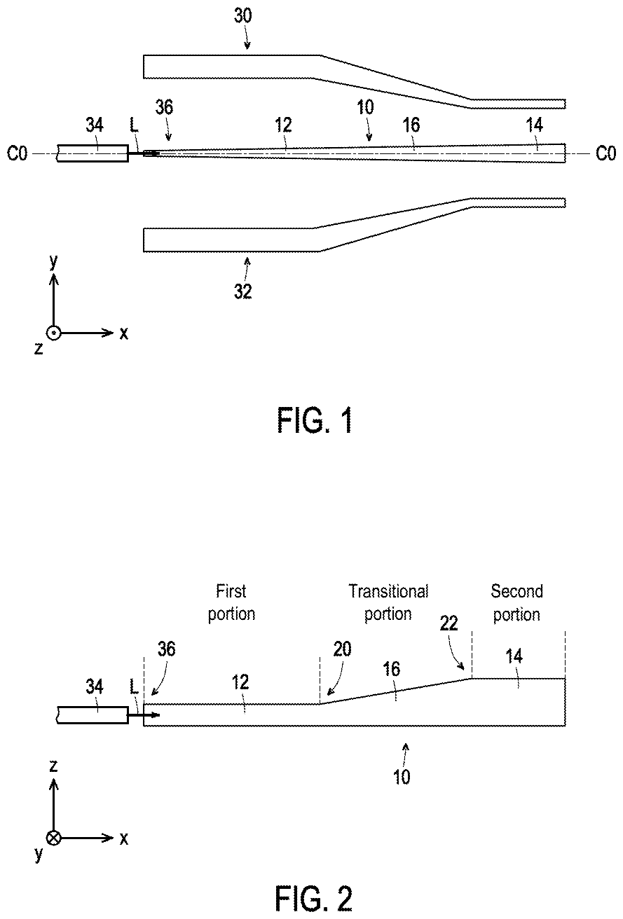

With reference to FIGS. 1 and 2, an optical structure including a waveguide 10 is shown by way of a top view in FIG. 1; and FIG. 2 shows a cut view of the waveguide 10 of the optical structure of FIG. 1 taken along cut C0-C0 indicated in FIG. 1. Without loss of generality, a Cartesian coordinate set of directions x, y, and z are indicated in FIGS. 1 and 2 (as well as in a number of other drawings herein). In this system, the plane of the semiconductor wafer or substrate (not shown) on which the optical structure is fabricated is denoted as an x-y plane, and the z-direction is transverse to the x-y plane of the wafer. Note that the depicted Cartesian coordinate set of directions x, y, z does not indicate any particular origin (i.e., no origin where x=0, y=0, and z=0 is indicated); rather, the depicted Cartesian coordinate set of directions indicate three mutually orthogonal x-, y-, and z-directions. In this coordinate system, a layer disposed on the wafer or substrate has a thickness in the z-direction. The thickness may also be referred to as a height, and the terms “thickness” and “height” are used interchangeably herein, and both refer to the direction perpendicular to the principal surface of the wafer or substrate denoted in the drawings as the z-direction.

With particular reference to FIG. 2, the illustrative waveguide 10 has a first portion 12, a second portion 14, and a transitional portion 16 with a first end 20 joining the first portion 12 and a second end 22 opposite the first end joining the second portion 14. The first portion 12 of the waveguide 10 has a smaller thickness (or height) than the second portion 14 of the waveguide 10, and the transitional portion 16 of the waveguide 10 has monotonically increasing thickness when moving along the +x-direction from its first end 20 to its second end 22. Notably, there is no abrupt step in the transitional portion 16 of the waveguide 10.

With particular reference back to FIG. 1, in the top view there seen the optical structure further includes (in addition to the waveguide 10) a first structure 30 disposed along a first side of the waveguide 10, and a second structure 32 disposed along a second side of the waveguide 10 opposite the first side. The first and second structures 30 and 32 are not optically operative components of the optical structure. Rather, as will be described later, the first and second structures 30 and 32 provide for control of a chemical-mechanical polishing (CMP) step of the fabrication of the waveguide 10. This CMP control provides the gradual increase in thickness of the transitional portion 16 of the waveguide 10. Hence, the first structure 30 is also referred to herein as a first CMP control structure 30; and likewise the second structure 32 is also referred to herein as a second CMP control structure 32.

FIGS. 1 and 2 further illustrate a light emitter 34 disposed at an input end 36 of the first portion 12 of the waveguide 10. As seen in FIG. 2, the input end 36 of the first portion 12 is distal from the transitional portion 16 of the waveguide 10. The light emitter 34 may, for example, be an output end of an optical fiber, or a laser, light emitting diode (LED), or the like. In operation, the waveguide 10 of the illustrative optical structure of FIGS. 1 and 2 receives light L output by the light emitter 34 into the input end 36 of the first portion of the waveguide 10. In a typical waveguide, there would be an abrupt step in height (i.e., a thickness step) between the lower-height first portion 12 and the higher-height second portion 14; and the abrupt step in height would introduce light reflection that reduces light transmission efficiency of the waveguide. In the illustrative waveguide 10, however, the gradual increase in thickness of the transitional portion 16 advantageously reduces or eliminates such reflections and substantially improves the optical efficiency of the waveguide 10, and in particular of light transmission from the first portion 12 through the transitional portion 16 to the second portion 14.

The illustrative transitional portion 16 of the waveguide 10 has a changing thickness which is linearly increasing from the first portion 12 of the waveguide 10 to the second portion 14 of the waveguide 10 (or, said another way, is linearly increasing from it first end 20 to its second end 22). More generally, to limit or eliminate light reflection the transitional portion 16 should have a changing thickness which is monotonically increasing from the first portion 12 of the waveguide 10 to the second portion 14 of the waveguide 10 (or, said another way, the changing thickness is monotonically increasing from it first end 20 to its second end 22).

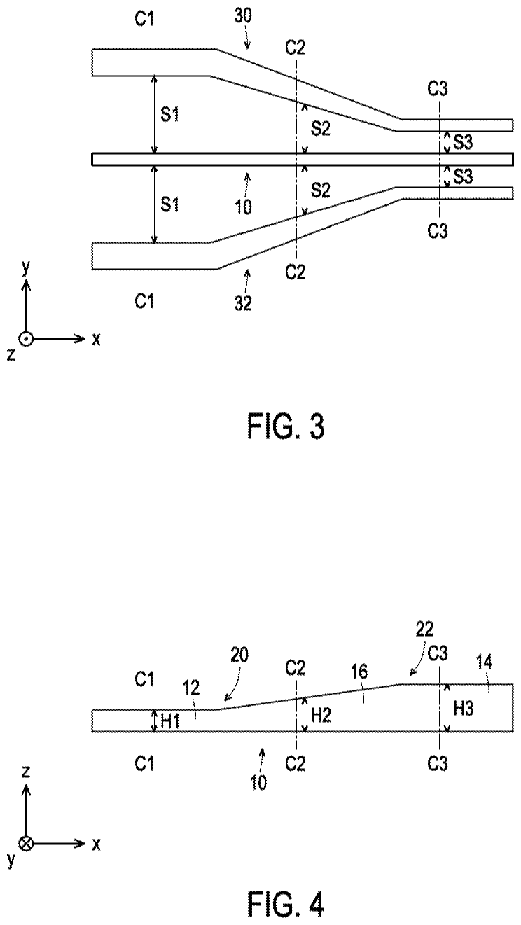

With reference now to FIGS. 3-5, formation of the gradually changing thickness of the transitional portion 16 of the waveguide 10 by way of control of a chemical-mechanical polishing (CMP) step is described. FIG. 3 shows the top view of FIG. 1 with certain dimensions indicated, while FIG. 4 shows the C0-C0 cut view of the waveguide 10 with certain dimensions indicated. Starting with FIG. 4, the first portion 12 of the waveguide 10 has a thickness or height H1, the second portion 14 of the waveguide 10 has a thickness or height H3 (where H3>H1), and the transitional portion 16 of the waveguide 10 has a gradually increasing thickness from its first end 20 to its second end 22, with a selected thickness H2 indicated in FIG. 2 for a cut line C2-C2 (where H1<H2<H3). FIG. 4 also indicates a cut line C1-C1 passing through the first portion 12, and a cut line C3-C3 passing through the second portion 14. Each cut plane C1-C1, C2-C2, and C3-C3 is a y-z plane using the x-y-z Cartesian directions indicated in the drawings. Note that while FIG. 4 depicts a certain cut line C1-C1 through the first portion 12, any cut line through the first portion 12 would have the same thickness H1 since the first portion 12 has a constant thickness along the x-direction; and likewise, while FIG. 4 depicts a certain cut line C3-C3 through the second portion 14, any cut line through the second portion 14 would have the same thickness H3 since the second portion 14 has a constant thickness along the x-direction. On the other hand, as a hypothetical cut line through the transitional portion 16 moves from its first end 20 to its second end 22 the height would increase, from the height H1 at the first end 20 to the height H3 at the second end 22. The illustrative cut plane C2-C2 with height H2 is thus an illustrative example.

Referencing FIG. 3, the corresponding cut planes C1, C2, and C3 passing through the first portion 12, transitional portion 16, and second portion 14 respectively, are again indicated. At the cut plane C1-C1 through the first portion 12, the first CMP control structure 30 is spaced apart from the waveguide 10 by a spacing S1 (along the y-direction); and likewise, the second CMP control structure 32 at the cut plane C1-C1 is spaced apart from the waveguide 10 by the same spacing S1. The first CMP control structure 30 has uniform spacing S1 over its entire length along the x-direction.

At the cut plane C3-C3 through the second portion 14, the first CMP control structure 30 is spaced apart from the waveguide 10 by a smaller spacing S3; and likewise, the second CMP control structure 32 at the cut plane C3-C3 is spaced apart from the waveguide 10 by the same spacing S3. The second CMP control structure 32 has uniform spacing S3 over its entire length along the x-direction.

On the other hand, along the transitional portion 16 of the waveguide 10 the CMP control structures 30 and 32 have deceasing spacing from the waveguide 10 when moving along the +x-direction from the first end 20 to the second end 22 of the transitional portion 16 of the waveguide 10. FIG. 3 depicts each of the CMP control structures 30 and 32 at the example cut plane C2-C2 having a spacing S2 from the waveguide 10 (where S1<S2<S3).

It is noted that to simplify the analysis depicted in FIGS. 3-5, the waveguide 10 is shown in FIG. 3 has having a uniform width in the y direction, thus neglecting the slight gradual increase in width in the y-direction of the waveguide 10 when moving along the +x-direction as depicted in FIG. 1.

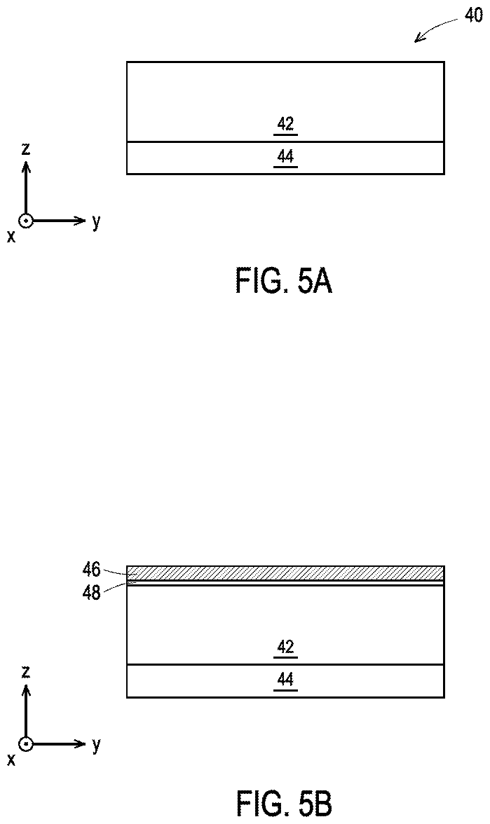

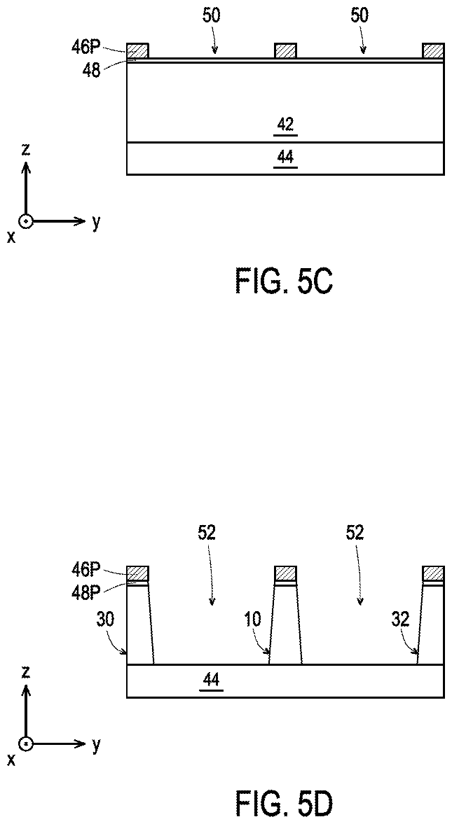

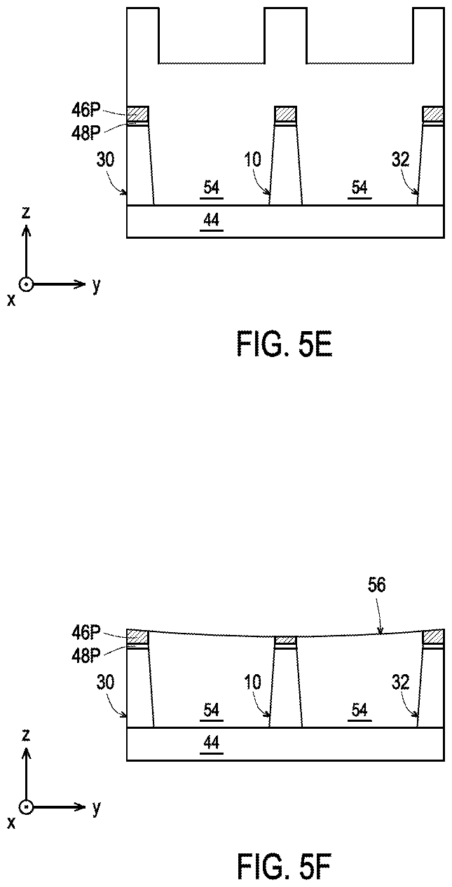

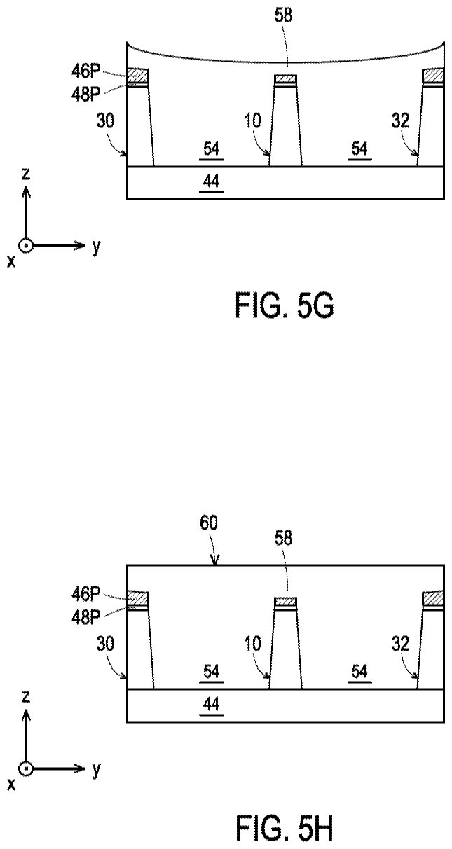

With reference now to FIGS. 5A-5H, a method of fabricating the optical structure including the waveguide 10 and CMP control structures 30 and 32 is illustrated by way of successive diagrammatically shown cut views taken along the cut C3-C3 indicated in FIGS. 3 and 4 at successive steps of the fabrication process. As labeled by Cartesian direction coordinates in each of FIGS. 5A-5H, the cut plane of the cut C3-C3 is a y-z cut plane which is perpendicular to the x-direction. In this illustrative example, the fabrication process starts with a silicon-on-insulator (SOI) wafer 40 as shown in FIG. 5A. The SOI wafer 40 includes a silicon layer 42 disposed on a buried oxide (BOX) layer 44. The SOI wafer 40 may, for example, be a commercial SOI wafer. The buried oxide layer 44 is described herein as a silicon dioxide layer as an illustrative example, but other suitable oxide materials are contemplated. The buried oxide layer 44 should have a refractive index which is less than the refractive index of silicon, so that the buried oxide layer 44 can serve as a lower-index cladding material beneath the waveguide 10 destined to be formed from the silicon layer 42. While an SOI wafer 40 is described as the base substrate for fabricating the optical structure, it will be appreciated that other base substrates can be employed that provide a silicon layer disposed on an oxide layer with refractive index less than that of the silicon wafer. As another nonlimiting illustrative example, the structure could be a silicon substate on which a suitable oxide layer is deposited followed by deposition of a silicon layer. Moreover, while the illustrative examples employ the silicon layer 42 for forming a silicon waveguide 10 (and silicon CMP control structures 30 and 32), it is contemplated to employ another waveguide material as the layer 42 so as to form a waveguide of a different material using the fabrication method here described. Thus, more generally, the layer 42 may be considered a waveguide layer 42, and the layer 44 may be considered a bottom cladding layer 44.

With reference to FIG. 5B, the fabrication process starts by deposition of an etch stop layer 46 on the silicon layer 42. In the illustrative example, an initial thin silicon dioxide (SiO₂) layer 48 is deposited before depositing the etch stop layer 46, but the initial SiO₂ layer 48 is optional. In the examples herein, the etch stop layer 46 is a silicon nitride (SiN) layer, but other etch stop layer materials are contemplated. The etch stop layer 46 is suitably deposited by chemical vapor deposition (CVD), physical vapor deposition (PVD), sputtering, or another deposition modality.

With reference to FIG. 5C, photolithographically patterned etching of the etch stop layer 46 is performed to remove the etch stop layer 46 except at locations corresponding to the destined waveguide 10 and CMP control structures 30 and 32. The photolithographically patterned etching entails disposing photoresist on the etch stop layer 46, performing a photolithographic exposure of the photoresist to form a latent image in the photoresist, developing the latent image to remove areas exposed to light (if a positive photoresist is used) or to remove areas not exposed to light (if a negative photoresist is used) so as to openings in the photoresist, followed by etching to remove the etch stop layer 46 in the openings of the photoresist to form corresponding openings 50 in the etch stop layer 46. In the illustrative example of FIG. 5C, the underlying SiO₂ layer 48 serves as an etch stop for the etching of the etch stop layer 46; however, in other contemplated embodiments if the etchant used to form the openings 50 is selective for silicon nitride (or other material forming the etch stop layer 50) over the silicon layer 42 (or other waveguide material making up the layer 42), then the SiO₂ layer 48 may optionally be suitably omitted. In FIG. 5C, the etch stop layer is now labeled as a patterned etch stop layer 46P due to the etching to form the openings 50, to indicate the patterning of this layer. Note that while not visible in the cut view along cut C3-C3 shown in FIG. 5C which employs a y-z cut plane, the patterned etch stop layer 46P if viewed in top view (i.e., along the z-direction) would have a pattern corresponding to the locations of the waveguide 10 and CMP control structures 30 and 32 as depicted in FIGS. 1 and 3.

With reference to FIG. 5D, the silicon layer 42 is etched through the openings 50 in the patterned etch stop layer 46P to remove the silicon layer 42 except in the areas underneath the patterned etch stop layer 46P. The etchant employed is highly selective for etching silicon (or other waveguide material making up the layer 42) over silicon nitride (or other etch stop material making up the patterned etch stop layer 46P). The etchant employed is also effective to remove the optional SiO₂ layer 48 except underneath the patterned etch stop layer 46P, so that this is now a patterned SiO₂ layer 48P as labeled in FIG. 5D. The silicon which remains underneath the patterned etch stop layer 46P after the etching forms the waveguide 10 and CMP control structures 30 and 32. The waveguide 10 and CMP control structures 30 and 32 at the stage diagrammatically depicted in FIG. 5D have the layout shown in FIGS. 1 and 3, but the waveguide 10 does not yet have the thickness (i.e., height) profile shown in FIGS. 2 and 4. Rather, at the stage diagrammatically depicted in FIG. 5D the waveguide 10 has a uniform height which is greater than (or at smallest, equal to) the thickness H3 labeled in FIG. 4 for the second portion 14 of the completed waveguide 10. The etching leaves the optical structure at the stage diagrammatically depicted in FIG. 5D with spaces 52 between the waveguide 10 and the CMP control structures 30 and 32.

With reference to FIG. 5E, the spaces 52 between the waveguide 10 and the CMP control structures 30 and 32 is filled with a cladding material 54. In the illustrative example, the cladding material 54 is silicon dioxide and hence, after the filling with the cladding material 54, the illustrative silicon waveguide 10 is surrounded, i.e., encapsulated, by cladding material comprising silicon dioxide. Namely, the waveguide 10 is clad on its bottom by the buried oxide 44 of the original SOI wafer 40 (see FIG. 5A) and on its lateral sides and top by the filling cladding material 54. Furthermore, since in the illustrative embodiment the buried oxide 44, the filling cladding material 54, and the patterned SiO₂ layer 48P are all silicon dioxide, at the fabrication stage diagrammatically shown in FIG. 5E these silicon dioxide regions form a continuum of silicon dioxide which encapsulates the waveguide 10, the CMP control structures 30 and 32, and the patterned etch stop layer 46P. In some embodiments, the filling of the spaces 52 between the waveguide 10 and the CMP control structures 30 and 32 with the silicon dioxide cladding material 54 is performed by a shallow trench isolation (STI) process. In a suitable STI process, an initial conformal layer of silicon dioxide is optionally formed by thermal oxidation, followed by deposition of silicon dioxide by CVD or another suitable deposition modality to a thickness sufficient to fill the spaces 52 and extend over and cover the waveguide 10 and CMP control structures 30 and 32 and the overlying patterned etch stop layer 46P, as diagrammatically shown in FIG. 5E.

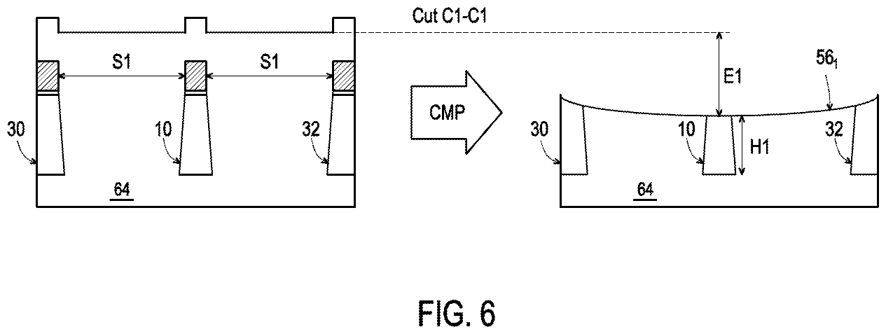

An STI process typically includes a subsequent planarization by chemical-mechanical polishing (CMP). This is described next with reference to FIG. 5F. CMP is sometimes referred to in the art as “chemical-mechanical planarization”. However, in the optical structure fabrication method here described, the CMP does not produce a planar surface. This is because the structure to which CMP is applied has a laterally varying structure imposed by the waveguide 10 and the CMP control structures 30 and 32. This laterally varying structure, as will be explained later herein with particular reference to FIG. 6, results in a thickness reduction of the silicon waveguide 10 by the CMP that varies in amount depending on the spacing between the waveguide 10 and the CMP control structures 30 and 32 (e.g., spacing S1 or S2 or S3 labeled in FIG. 3). The amount of thickness reduction may also depend on the width of the CMP control structures (i.e., width along the y-direction), as a larger width for the CMP control structures can increase the resistance to the CMP. The thickness reduction may also depend on width of the waveguide 10 (see, e.g., FIG. 1 showing the waveguide width in the y-direction increasing when moving along the +x-direction—a wider waveguide presents more resistance to the CMP and hence will have less thickness reduction).

With reference to FIG. 5F, the impact of the CMP control structures 30 and 32 is illustrated for the cut C3-C3 through the second portion 14 of the waveguide 10. (In the C3-C3 cut plane, the CMP control structures 30 and 32 have spacing S3 away from the waveguide 10, as labeled in FIG. 3). The CMP control structures 30 and 32 present more resistance to the CMP than does the silicon dioxide cladding 54 disposed between the waveguide 10 and each of the CMP control structures 30 and 32. This greater resistance is due to the silicon dioxide of the cladding 54 presenting less resistance to the CMP than does the silicon of the CMP control structures 30 and 32, as well as that the patterned etch stop 46P disposed on the CMP control structures 30 and 32 is typically more resistant to the CMP than the silicon dioxide of the cladding 54. As recognized herein, this results in the CMP not providing perfect planarization, but rather producing a diagrammatically shown bowed or dished surface 56. The bowed or dished surface 56 results from the CMP more efficiently removing material of the cladding 54 and waveguide 10 compared with the CMP control structures 30 and 32 which are more resistant to the CMP processing. Notably, the amount of bowing or dishing of the surface 56 produced by the CMP will depend on the structure of the CMP control structures 30 and 32, particularly the spacing of these structures away from the waveguide 10. This will be discussed in greater detail below with reference to FIG. 6.

In some embodiments, the method of fabricating the optical structure including the waveguide 10 may terminate at the structure shown in FIG. 5F.

With reference to FIG. 5G, in other embodiments an optional further process operation of depositing additional silicon dioxide (or, more generally, additional cladding material) 58 may be performed. This may be beneficial if, for example, the CMP performed to produce the structure as shown in FIGURE#5F entirely removes the silicon dioxide cladding from the top surface of the waveguide 10 (see the examples for cut C1-C1 and cut C2-C2 shown in FIG. 6). In this case, the additional deposited silicon dioxide 58 ensures that the waveguide 10 is entirely embedded in (i.e., encompassed by) the (illustrative silicon dioxide) cladding material with lower refractive index than that of the (illustrative silicon) of the waveguide 10, so that light is guided through the waveguide 10 by total internal reflection (TIR).

With reference to FIG. 5H, in some embodiments an optional second CMP process may be performed after depositing the additional silicon dioxide 58, to provide a planarized surface 60 for the final optical structure. Because this second CMP operates only on a uniform layer of silicon dioxide (or other cladding material, in other embodiments) and does not penetrate deeply enough to expose the CMP control structures 30 and 32, this second CMP is expected to produce a more planar final surface (as opposed to the bowed or dished surface 56 produced by the first CMP due to interaction with the CMP control structures 30 and 32).

The fabrication method has been described with reference to FIGS. 5A-5H which diagrammatically depict successive cut views at the cut plane C3-C3 through the second portion 14 of the waveguide 10. These views do not illustrate how the gradually changing thickness along the x-direction of the transitional portion 16 of the waveguide 10 is obtained.

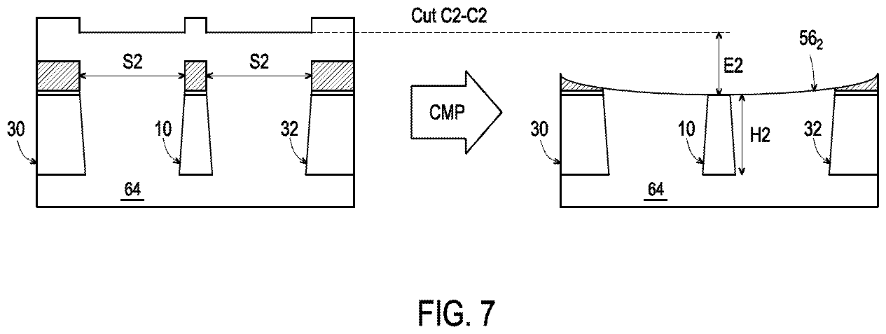

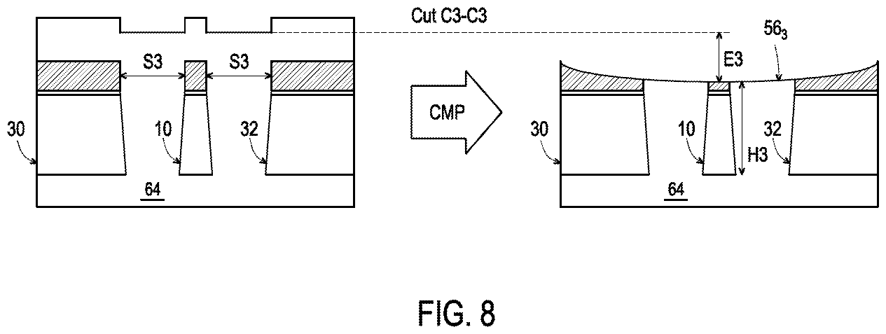

With reference back to FIGS. 3 and 4, and with further reference now to FIGS. 6-8, it is explained how the CMP control structures 30 and 32 control the CMP to provide the height profile of the waveguide 10 shown in FIG. 4, and in the particular example how the gradual increase in thickness of the transitional portion 16 from H1 to H3 when moving along the +x-direction is obtained. FIG. 6 diagrammatically illustrates cut views for cut C1-C1; FIG. 7 diagrammatically illustrates cut views for cut C2-C2; and FIG. 8 diagrammatically illustrates cut views for cut C3-C3. Each of FIGS. 6, 7, and 8 depicts two cut views: one presenting the structure before the CMP processing (as previously described with reference to FIG. 5F), and one presenting the structure after the CMP process. To clarify, each of FIGS. 6, 7, and 8 include an arrow (->) labeled “CMP” to clarify the before/after cut views. The lefthand (before-CMP) cut view of FIG. 6 for cut C1-C1 also labels the spacings S1 of the first and second CMP control structures 30 and 32 at the cut C1-C1, which are also labeled in FIG. 3. The lefthand (before-CMP) cut view of FIG. 7 for cut C2-C2 also labels the spacings S2 of the first and second CMP control structures 30 and 32 at the cut C2-C2, which are also labeled in FIG. 3. The lefthand (before-CMP) cut view of FIG. 8 for cut C3-C3 also labels the spacings S3 of the first and second CMP control structures 30 and 32 at the cut C3-C3, which are also labeled in FIG. 3. Furthermore, for simplicity the silicon dioxide cladding is labeled in the aggregate as cladding 64 (as opposed to separately labeling the cladding components 44, 48P, and 54 as was done in the successive cut views of FIGS. 6A-6H). As previously discussed, S1>S2>S3, as also seen by comparing the lefthand (before-CMP) drawings of FIGS. 6, 7, and 8.

As previously discussed when describing the CMP processing with reference to FIG. 5F, The CMP control structures 30 and 32 present more resistance to the CMP than does the silicon dioxide cladding 54 disposed between the waveguide 10 and each of the CMP control structures 30 and 32, due to the silicon dioxide cladding 54 presenting less resistance than the silicon of the CMP control structures 30 and 32, and due to the patterned etch stop 46P disposed on the CMP control structures 30 and 32 being more resistant to the CMP than the silicon dioxide cladding 54. The amount of resistance to the CMP is also dependent on the width of the waveguide 10. In the example of FIG. 1, the waveguide 10 has a width (along the y-direction) which increases with increasing distance along the +x direction, so that the waveguide 10 itself also presents increasing resistance to the CMP with increasing distance along the +x direction. These effects produces the bowed or dished surface 56 after the CMP as indicated in FIG. 5F. It is further noted that the amount of thickness reduction may also depend on the width of the CMP control structures (i.e., width along the y-direction), as a larger width for the CMP control structures can increase the resistance to the CMP.

The amount of the bowing or dishing is expected to increase with increasing spacing between the waveguide 10 and the CMP control structures 30 and 32. This spacing is S1 for cut C1-C1 of FIG. 6, and is a smaller spacing S2 for the cut C2-C2 of FIG. 7, and a still smaller spacing S3 for the cut C3-C3 of FIG. 8. That is, S1>S2>S3. Consequently, the bowing or dishing should be greatest for the largest spacing S1 of FIG. 6, and should be least for the smallest spacing S3 of FIG. 8, and should be intermediate for the intermediate spacing S2 of FIG. 7. As seen in FIGS. 3 and 4, in the transitional portion 16 of the waveguide 10 the spacing between the waveguide 10 and the CMP control structures 30 and 32 decreases in continuous fashion from the largest spacing S1 at the end 20 of the transitional portion 16 to the smallest spacing S3 at the opposite end 22 of the transitional portion 16, with the spacing S2 being at an intermediate point between the ends 20 and 22. This decreasing spacing is expected to produce a gradual reduction in the bowing or dishing produced by the CMP along the x-direction from end 20 to end 22 of the transitional portion 16, and hence the thickness reduction produced by the CMP is expected to be gradually less and less when moving from the end 20 to the end 22. This produces the desired gradually increasing thickness (or height) of the transitional portion 16 of the waveguide 10. This effect is illustrated in FIGS. 6, 7, and 8 by the labeled bowed or dished surface 561 for cut C1-C1 shown in FIG. 6; which has greater bowing than the labeled bowed or dished surface 562 for cut C2-C2 shown in FIG. 7; which has greater bowing than the labeled bowed or dished surface 563 for cut C3-C3 shown in FIG. 8.

In addition to changes in bowing or dishing due to the different spacings S1>S2>S3, the total amount of material removed is expected to depend on the overall resistance imposed by the waveguide 10 itself. This depends on the width of the waveguide 10. In the example of FIG. 1, the width of the transitional portion 16 of the waveguide 10 gradually increases from the first end 20 of the transitional portion 16 of the waveguide 10 to the second end 22 of the transitional portion 16 of the waveguide 10.

In general, the slope or curvature of the thickness of the transitional portion 16 of the waveguide 10 will depend on the spacing between the waveguide 10 and the CMP control structures 30, 32, and may also depend on other factors such as the width of the waveguide 10 itself. To design the waveguide 10 with a transitional portion 16 having a thickness variation along its length with a particular desired slope or curvature, a test matrix of test structures can be fabricated with different spacing variations (e.g., using different test structures with layouts corresponding to FIG. 3 but with different values for S1, S2, and/or S3 in each test structure) and optionally also different waveguide widths (e.g., as shown in FIG. 1), and CMP processing can be performed on these test structures, followed by characterization of the thickness slope or curvature obtained for the transitional region 16 in each test case using a technique such as cross-sectional microscopy, profilometry, or the like to determine an optimal geometry for the optical structure to obtain the desired thickness slope or curvature for the transitional region 16 of the waveguide 10.

With reference back to FIGS. 1 and 2, in that example the transitional portion 16 was used to minimize or eliminate optical reflection of light L input to the input end 36 of the first portion 12 by the light emitter 34, thereby increasing the optical efficiency of the waveguide 10. It will be appreciated that this is just one of many possible applications of waveguides with the illustrative gradual transition that does not include any light-reflecting thickness (i.e., height) steps.

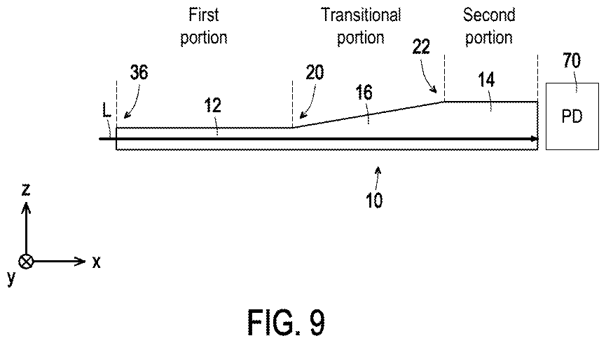

With reference to FIG. 9, another nonlimiting illustrative application example is shown. The example of FIG. 9 employs the same waveguide 10 including the first portion 12, second portion 14, and interposed transitional portion 16 with first end 20 connecting with the first portion 12 and second end 22 connecting with the second portion 14. However, the application depicted in FIG. 9 is different. In FIG. 9, the waveguide 10 is delivering light L to a photodetector 70, such as a photodiode or the like. In this case, the second portion 14 of the waveguide has a larger thickness (i.e., height) to accommodate a larger size of the photodetector 70. The transitional portion 16 in this application provides for transmission of the light L from the lower-thickness first portion 12 to the larger-thickness second portion 14 with reduced or eliminated light reflection. Again, it is to be understood that the light input coupling application shown in FIGS. 1 and 2 as well as the light output coupling application shown in FIG. 9 are nonlimiting illustrative applications, and other applications are contemplated such as providing couplings from a waveguide of smaller height to a waveguide of greater height with reduced or eliminated light reflections.

In the following, some further embodiments are described.

In a nonlimiting illustrative embodiment, a method of fabricating a waveguide is disclosed. The method includes: forming a stack of layers including an etch stop layer disposed on a waveguide layer disposed on a bottom cladding layer; patterning the etch stop layer and etching the waveguide layer after the patterning to form a waveguide and a chemical-mechanical polishing (CMP) control structure; filling a space between the waveguide and the CMP control structure with a cladding material; and performing CMP to reduce a thickness of the waveguide, wherein the CMP control structure controls the CMP of the waveguide to form a transitional portion of the waveguide having a gradually changing thickness.

In a nonlimiting illustrative embodiment, an optical structure comprises a waveguide having a first portion, a second portion, and a transitional portion with a first end joining the first portion and a second end joining the second portion. A thickness of the first portion of the waveguide is smaller than a thickness of the second portion of the waveguide. The transitional portion of the waveguide has a thickness that gradually increases from the first thickness at the first end of the transitional portion of the waveguide to the second thickness at the second end of the transitional portion of the waveguide.

In a nonlimiting illustrative embodiment, a method of fabricating a waveguide having a variable thickness formed by chemical-mechanical polishing (CMP) is disclosed. The method includes: depositing an etch stop layer on a silicon layer of a silicon-on- insulator (SOI) wafer; patterning the etch stop layer and etching the silicon layer after the patterning to form a first CMP control structure, a second CMP control structure, and a silicon waveguide disposed between the first CMP control structure and the second CMP control structure; filling spaces between the silicon waveguide and the first and second CMP control structures with silicon dioxide using a shallow trench isolation (STI) process; and performing CMP to reduce a thickness of the silicon waveguide, wherein the first and second CMP control structures control the CMP of the silicon waveguide to form a transitional portion of the silicon waveguide having a gradually changing thickness.

In a nonlimiting illustrative embodiment, a waveguide has a first and second portions, and a transitional portion with a first end joining the first portion and a second end joining the second portion. The first portion has a first thickness that is smaller than a second thickness of the second portion. The transitional portion has a thickness that gradually increases from the first thickness at its first end to the second thickness at its second end. In a fabrication method employing chemical-mechanical polishing (CMP), first and second CMP control structures are disposed on opposite sides of the waveguide. Spaces between the waveguide and the CMP control structures are filled with cladding material. CMP is performed to reduce a thickness of the waveguide. The CMP control structures control the CMP of the waveguide to form the transitional portion of the waveguide having the gradually increasing thickness.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A waveguide fabrication method comprising:
forming a stack of layers including an etch stop layer disposed on a waveguide layer disposed on a bottom cladding layer;
patterning the etch stop layer and etching the waveguide layer after the patterning to form a waveguide and a chemical-mechanical polishing (CMP) control structure;
filling a space between the waveguide and the CMP control structure with a cladding material; and
performing CMP to reduce a thickness of the waveguide, wherein the CMP control structure controls the CMP of the waveguide to form a transitional portion of the waveguide having a gradually changing thickness.

2. The method of claim 1, wherein the CMP control structure includes:
a first CMP control structure disposed along a first side of the waveguide and spaced apart from the waveguide by a spacing that gradually changes over a portion of the first CMP control structure disposed along the transitional portion of the waveguide; and
a second CMP control structure disposed along a second side of the waveguide opposite the first side of the waveguide and spaced apart from the waveguide by a spacing that gradually changes over a portion of the second CMP control structure disposed along the transitional portion of the waveguide;
wherein the gradually changing spacings of the first and second CMP control structures disposed along the transitional portion of the waveguide controls the CMP of the waveguide to produce the gradually changing thickness of the transitional portion of the waveguide.

3. The method of claim 1, wherein the waveguide has a width that gradually increases over the transitional portion of the waveguide.

4. The method of claim 1, wherein the waveguide layer comprises silicon and the cladding material comprises silicon dioxide.

5. The method of claim 4, wherein the etch stop layer comprises silicon nitride.

6. The method of claim 4, wherein the space between the waveguide and the CMP control structure is filled with the cladding material using a shallow trench isolation (STI) process.

7. The method of claim 1, wherein the CMP control structure controls the CMP of the waveguide to produce the transitional portion of the waveguide having the changing thickness which is monotonically increasing from a first portion of the waveguide to a second portion of the waveguide, wherein after performing the CMP a thickness of the first portion of the waveguide is smaller than a thickness of the second portion of the waveguide.

8. The method of claim 7, further comprising one of:
disposing a light emitter at an input end of the first portion of the waveguide wherein the input end is distal from the transitional portion of the waveguide; or
disposing a light detector at an output end of the main portion of the waveguide wherein the input end is distal from the transitional portion of the waveguide

9. The method of claim 7, wherein after performing the CMP the transitional portion of the waveguide does not include an abrupt thickness step.

10. The method of claim 1, wherein the forming of the stack of layers includes:
depositing the etch stop layer on a silicon-on-insulator (SOI) wafer;
wherein the waveguide layer of the stack of layers comprises a silicon layer of the SOI wafer and the cladding layer of the stack of layers comprises a buried oxide layer of the SOI wafer.

11. An optical structure comprising:
a waveguide having a first portion, a second portion, and a transitional portion with a first end joining the first portion and a second end joining the second portion;
wherein a thickness of the first portion of the waveguide is smaller than a thickness of the second portion of the waveguide; and
wherein the transitional portion of the waveguide has a thickness that gradually increases from the first thickness at the first end of the transitional portion of the waveguide to the second thickness at the second end of the transitional portion of the waveguide.

12. The optical structure of claim 11, wherein the waveguide comprises silicon.

13. The optical structure of claim 12, further comprising:
a first structure comprising silicon disposed along a first side of the waveguide and spaced apart from the waveguide by a spacing that gradually changes over a portion of the first structure disposed along the transitional portion of the waveguide; and
a second structure comprising silicon disposed along a second side of the waveguide opposite the first side of the waveguide and spaced apart from the waveguide by a spacing that gradually changes over a portion of the second structure disposed along the transitional portion of the waveguide.

14. The optical structure of claim 12, wherein a width of the transitional portion of the waveguide gradually increases from the first end of the transitional portion of the waveguide to the second end of the transitional portion of the waveguide.

15. The optical structure of claim 12, further comprising:
a cladding comprising silicon dioxide surrounding the waveguide at least on a bottom and sides of the waveguide.

16. The optical structure of claim 11, wherein the transitional portion of the waveguide does not have any abrupt thickness step.

17. A method of fabricating a waveguide having a variable thickness formed by chemical-mechanical polishing (CMP), the method comprising:
depositing an etch stop layer on a silicon layer of a silicon-on-insulator (SOI) wafer;
patterning the etch stop layer and etching the silicon layer after the patterning to form a first CMP control structure, a second CMP control structure, and a silicon waveguide disposed between the first CMP control structure and the second CMP control structure;
filling spaces between the silicon waveguide and the first and second CMP control structures with silicon dioxide using a shallow trench isolation (STI) process; and
performing CMP to reduce a thickness of the silicon waveguide, wherein the first and second CMP control structures control the CMP of the silicon waveguide to form a transitional portion of the silicon waveguide having a gradually changing thickness.

18. The method of claim 17, wherein:
a spacing between the first CMP control structure and the silicon waveguide gradually changes over a portion of the first CMP control structure disposed along the transitional portion of the silicon waveguide; and
a spacing between the second CMP control structure and the silicon waveguide gradually changes over a portion of the second CMP control structure disposed along the transitional portion of the silicon waveguide;
wherein the gradually changing spacing of the first CMP control structure and the gradually changing spacing of second CMP control structure controls the CMP of the silicon waveguide to produce the gradually changing thickness of the transitional portion of the silicon waveguide.

19. The method of claim 17, wherein the etch stop layer comprises silicon nitride.

20. The method of claim 17, wherein the filling of the spaces between the silicon waveguide and the first and second CMP control structures comprises performing a shallow trench isolation (STI) process to fill the spaces between the silicon waveguide and the first and second CMP control structures.
